(19) United States
(12) Patent Application Publication
(10) Pub. No.: US 2004/0118997 A1
(43) Pub. Date: Jun. 24, 2004

(54) Tapered fiber optic strain gauge using cavity ring-down spectroscopy

(76) Inventors: Kevin K. Lehmann, Lawrence, NJ (US); Peter B. Tarsa, Duxbury, MA (US); Paul Rabinowitz, Bridgewater, NJ (US)

Correspondence Address: RATNERPRESTIA, P O BOX 980, VALLEY FORGE, PA, 19482-0980, US

(21) Appl. No.: 10/644,137

(22) Filed: Aug. 20, 2003

Related U.S. Application Data
(63) Continuation-in-part of application No. 10/157,400, filed on May 29, 2002.
Application No. 10/157,400 is a continuation-in-part of application No. 10/017,367, filed on Dec. 12, 2001.

(51) Int. Cl. G01J 1/04; G01J 1/42

(52) U.S. Cl. 250/227.14

(57) ABSTRACT

An apparatus for measurement of strain in a material. The apparatus comprises a passive fiber optic ring; at least one sensor having a predetermined shape and in line with the fiber optic ring, the at least one sensor coupled to the substrate; coupling means for i) introducing a portion of radiation emitted by the coherent source to the passive fiber optic ring and ii) receiving a portion of the radiation resonant in the passive fiber optic ring; a detector for detecting a level of the radiation received by the coupling means and generating a signal responsive thereto; and a processor coupled to the detector for determining a level of the strain inducing into the substrate based on a rate of decay of the signal generated by the detector.

This application is a Continuation-in-Part of pending application Ser. No. 10/157,400 filed on May 29, 2002, which is a Continuation-in-Part of pending application Ser. No. 10/017,367 filed on Dec. 12, 2001.

### FIELD OF THE INVENTION

This invention relates generally to cavity ring-down detection systems and, in particular, is directed to fiber optic strain gauge using cavity ring-down spectroscopy.

### BACKGROUND OF THE INVENTION

Although this application relates to strain measurement in materials using cavity ring-down detection, the following background in absorption spectroscopy may be useful in understanding the present invention.

Referring now to the drawing, wherein like reference numerals refer to like elements throughout, FIG. 1 illustrates the electromagnetic spectrum on a logarithmic scale. The science of spectroscopy studies spectra. In contrast with sciences concerned with other parts of the spectrum, optics particularly involves visible and near-visible light—a very narrow part of the available spectrum which extends in wavelength from about 1 mm to about 1 nm. Near visible light includes colors redder than red (infrared) and colors more violet than violet (ultraviolet). The range extends just far enough to either side of visibility that the light can still be handled by most lenses and mirrors made of the usual materials. The wavelength dependence of optical properties of materials must often be considered.

Absorption-type spectroscopy offers high sensitivity, response times on the order of microseconds, immunity from poisoning, and limited interference from molecular species other than the species under study. Various molecular species can be detected or identified by absorption spectroscopy. Thus, absorption spectroscopy provides a general method of detecting important trace species. In the gas phase, the sensitivity and selectivity of this method is optimized because the species have their absorption strength concentrated in a set of sharp spectral lines. The narrow lines in the spectrum can be used to discriminate against most interfering species.

In many industrial processes, the concentration of trace species in flowing gas streams and liquids must be measured and analyzed with a high degree of speed and accuracy. Such measurement and analysis is required because the concentration of contaminants is often critical to the quality of the end product. Gases such as N₂, O₂, H₂, Ar, and He are used to manufacture integrated circuits, for example, and the presence in those gases of impurities—even at parts per billion (ppb) levels—is damaging and reduces the yield of operational circuits. Therefore, the relatively high sensitivity with which water can be spectroscopically monitored is important to manufacturers of high-purity gases used in the semiconductor industry. Various impurities must be detected in other industrial applications. Further, the presence of impurities, either inherent or deliberately place, in liquids have become of particular concern of late.

Spectroscopy has obtained parts per million (ppm) level detection for gaseous contaminants in high-purity gases. Detection sensitivities at the ppb level are attainable in some cases. Accordingly, several spectroscopic methods have been applied to such applications as quantitative contamination monitoring in gases, including: absorption measurements in traditional long pathlength cells, photoacoustic spectroscopy, frequency modulation spectroscopy, and intracavity laser absorption spectroscopy. These methods have several features, discussed in U.S. Pat. No. 5,528,040 issued to Lehmann, which make them difficult to use and impractical for industrial applications. They have been largely confined, therefore, to laboratory investigations.

In contrast, cavity ring-down spectroscopy (CRDS) has become an important spectroscopic technique with applications to science, industrial process control, and atmospheric trace gas detection. CRDS has been demonstrated as a technique for the measurement of optical absorption that excels in the low-absorbance regime where conventional methods have inadequate sensitivity. CRDS utilizes the mean lifetime of photons in a high-finesse optical resonator as the absorption-sensitive observable.

Typically, the resonator is formed from a pair of nominally equivalent, narrow band, ultra-high reflectivity dielectric mirrors, configured appropriately to form a stable optical resonator. A laser pulse is injected into the resonator through a mirror to experience a mean lifetime which depends upon the photon round-trip transit time, the length of the resonator, the absorption cross section and number density of the species, and a factor accounting for intrinsic resonator losses (which arise largely from the frequency-dependent mirror reflectivities when diffraction losses are negligible). The determination of optical absorption is transformed, therefore, from the conventional power-ratio measurement to a measurement of decay time. The ultimate sensitivity of CRDS is determined by the magnitude of the intrinsic resonator losses, which can be minimized with techniques such as superpolishing that permit the fabrication of ultra-low-loss optics.

At present, CRDS is limited to spectroscopic regions where high reflectivity dielectric mirrors can be used. This has significantly limited the usefulness of the method in much of the ultraviolet and infrared regions, because mirrors with sufficiently high reflectivity are not presently available. Even in regions where suitable dielectric mirrors are available, each set of mirrors only allows for operation over a small range of wavelengths, typically a fractional range of a few percent. Further, construction of many dielectric mirrors requires use of materials that may degrade over time, especially when exposed to chemically corrosive environments. Because these present limitations restrict or prevent the use of CRDS in many potential applications, there is a clearly recognized need to improve upon the current state of the art with respect to resonator construction.

The article by A. Pipino et al., “Evanescent wave cavity ring-down spectroscopy with a total-internal reflection minicavity,” Rev. Sci. Instrum. 68 (8) (August 1997), presents one approach to an improved resonator construction. The approach uses a monolithic, total internal reflection (TIR) ring resonator of regular polygonal geometry (e.g., square and octagonal) with at least one convex facet to induce stability. A light pulse is totally reflected by a first prism located outside and in the vicinity of the resonator, creating an evanescent wave which enters the resonator and excites the stable modes of the resonator through photon tunneling. When light impinges on a surface of lower index of refraction that the propagation medium at greater than a critical angle, it reflects completely. J. D. Jackson, “Classical Electrodynamics,” Chapter 7, John Wiley & Sons, Inc.: New York, N.Y. (1962). A field exists, however, beyond the point of reflection that is non-propagating and decays exponentially with distance from the interface. This evanescent field carries no power in a pure dielectric medium, but attenuation of the reflected wave allows observation of the presence of an absorbing species in the region of the evanescent field. F. M. Mirabella (ed.), “Internal Reflection Spectroscopy,” Chapter 2, Marcel Dekker, Inc.: New York, N.Y. (1993).

The absorption spectrum of matter located at the totally reflecting surfaces of the resonator is obtained from the mean lifetime of a photon in the monolithic resonator, which is extracted from the time dependence of the signal received at a detector by out coupling with a second prism (also a totally reflecting prism located outside, but in the vicinity of, the resonator). Thus, optical radiation enters and exits the resonator by photon tunneling, which permits precise control of input and output coupling. A miniature-resonator realization of CRDS results and the TIR-ring resonator extends the CRDS concept to condensed matter spectroscopy. The broadband nature of TIR circumvents the narrow bandwidth restriction imposed by dielectric mirrors in conventional gas-phase CRDS. The work of A. Pipino et al. is only applicable to TIR spectroscopy, which is intrinsically limited to short overall absorption pathlengths, and thus powerful absorption strengths. In contrast, the present invention provides long absorption pathlengths and thus allows for detection of weak absorption strengths.

Various novel approaches to mirror based CRDS systems are provided in U.S. Pat. Nos. 5,973,864, 6,097,555, 6,172,823 B1, and 6,172,824 B1 issued to Lehmann et al., and incorporated herein by reference. These approaches teach the use of a near-confocal resonator formed by two reflecting elements or prismatic elements.

FIG. 2 illustrates a prior art CRDS apparatus 10. As shown in FIG. 2, light is generated from a narrow band, tunable, continuous wave diode laser 20. Laser 20 is temperature tuned by a temperature controller 30 to put its wavelength on the desired spectral line of the analyte. An isolator 40 is positioned in front of and in line with the radiation emitted from laser 20. Isolator 40 provides a one-way transmission path, allowing radiation to travel away from laser 20 but preventing radiation from traveling in the opposite direction. Single mode fiber coupler (F.C.) 50 couples the light emitted from laser 20 into the optical fiber 48. Fiber coupler 50 is positioned in front of and in line with isolator 40. Fiber coupler 50 receives and holds optical fiber 48 and directs the radiation emitted from laser 20 toward and through a first lens 46. First lens 46 collects and focuses the radiation. Because the beam pattern emitted by laser 20 does not perfectly match the pattern of light propagating in optical fiber 48, there is an inevitable mismatch loss.

The laser radiation is approximately mode-matched into a ring down cavity (RDC) cell 60. A reflective mirror 52 directs the radiation toward a beam splitter 54. Beam splitter 54 directs about 90%, of the radiation through a second lens 56. Second lens 56 collects and focuses the radiation into cell 60. The remaining radiation passes through beam splitter 54 and is directed by a reflective mirror 58 into an analyte reference cell 90.

The radiation which is transmitted through analyte reference cell 90 is directed toward and through a fourth lens 92. Fourth lens 92 is aligned between analyte reference cell 90 and a second photodetector 94 (PD 2). Photodetector 94 provides input to computer and control electronics 100.

Cell 60 is made from two, highly reflective mirrors 62, 64, which are aligned as a near confocal etalon along an axis, a. Mirrors 62, 64 constitute the input and output windows of cell 60. The sample gas under study flows through a narrow tube 66 that is coaxial with the optical axis, a, of cell 60. Mirrors 62, 64 are placed on adjustable flanges or mounts that are sealed with vacuum tight bellows to allow adjustment of the optical alignment of cell 60.

Mirrors 62, 64 have a high-reflectivity dielectric coating and are oriented with the coating facing inside the cavity formed by cell 60. A small fraction of laser light enters cell 60 through front mirror 62 and “rings” back and forth inside the cavity of cell 60. Light transmitted through rear mirror 64 (the reflector) of cell 60 is directed toward and through a third lens 68 and, in turn, imaged onto a first photodetector 70 (PD 1). Each of photodetectors 70, 94 converts an incoming optical beam into an electrical current and, therefore, provides an input signal to computer and control electronics 100. The input signal represents the decay rate of the cavity ring down.

FIG. 3 illustrates optical path within a prior art CRDS resonator 100. As shown in FIG. 3, resonator 100 for CRDS is based upon using two Brewster's angle retroreflector prisms 50, 52. The polarizing or Brewster's angle, Θ_{B}, is shown relative to prism 50. Incident light 12 and exiting light 14 are illustrated as input to and output from prism 52, respectively. The resonant optical beam undergoes two total internal reflections without loss in each prism 50, 52 at about 45°, an angle which is greater than the critical angle for fused quartz and most other common optical prism materials. Light travels between prisms 50, 52 along optical axis 54.

The inventors have discovered that the advantages provided by CRDS are applicable in measuring strain induced in materials. Conventional strain measuring devices rely on resistance changes or signal loss to determine the level of strain induced in a material. These approaches have disadvantages, however, in that the insensitivity inherent in these systems renders them inadequate to measure minute changes in the material under examination.

To overcome the shortcomings of the known approaches to measuring strain, a new optic-fiber based strain gauge using cavity ring-down spectroscopy is provided.

### SUMMARY OF THE INVENTION

In view of the disadvantages in the prior art, and in view of its purposes, the present invention provides an apparatus for use with a coherent source of radiation to measure strain induced into a substrate. The apparatus comprises a passive fiber optic ring; at least one sensor having a predetermined shape and in line with the fiber optic ring, the at least one sensor coupled to the substrate; coupling means for i) introducing a portion of radiation emitted by the coherent source into the passive fiber optic ring and ii) receiving a portion of the radiation resonant in the passive fiber optic ring; a detector for detecting a level of the radiation received by the coupling means and generating a signal responsive thereto; and a processor coupled to the detector for determining a level of the strain inducing into the substrate based on a rate of decay of the radiation in the passive fiber optic ring.

According to another aspect of the invention, the predetermined shape is a slack area formed between ends of the sensor where it is coupled to the substrate.

According to a further aspect of the invention, the signal generated by the detector is based on a change in the predetermined shape of the sensor as the strain is induced into the substrate.

According to yet another aspect of the invention, the apparatus further comprises a filter placed in an optical path between the coupling means and the detector to selectively pass the received portion of radiation from the passive fiber optic ring to the detector.

According to a further aspect of the invention, the filter passes radiation to the detector based on a wavelength of the radiation.

According to yet another aspect of the invention, the coupling means includes i) a first coupler for introducing the portion of the radiation emitted by the coherent source to a first section of the optical fiber and ii) a second coupler for receiving the portion of the radiation in the optical fiber at a second section thereof.

According to still another aspect of the invention, the sensor has a tapered portion formed between ends of the sensor and exposed to a surrounding ambient.

According to yet a further aspect of the invention, the apparatus comprises an isolator coupled between the laser and the coupling means and in line with the radiation emitted from the laser, the isolator minimizing noise in the laser.

According to another aspect of the invention, the dissipation of the radiation from the fiber as the strain is induced in the substrate changes a rate of decay of the radiation received by the coupling means.

According to yet another aspect of the invention, the apparatus further comprises control means to deactivate the laser based on the receiving means receiving radiation from the optical fiber after the input detector determines that the laser provided energy to the optical fiber.

According to still another aspect of the invention, a method of measuring strain in a material comprises forming a sensor from an optical fiber by tapering a portion the optical fiber; coupling the sensor to the material such that a portion between the ends of the sensor has a predetermined amount of slack; exposing the material to a strain; emitting radiation from a coherent source; coupling at least a portion of the radiation emitted from the coherent source into the fiber optic ring; receiving a portion of the radiation traveling in the fiber optic ring; and determining a level of strain based on a first rate of decay of the radiation within the fiber optic ring.

According to yet a further aspect of the invention, an evanescent field of the radiation traveling within the fiber is exposed to an ambient surrounding the material.

According to yet another aspect of the invention, the method further comprises determining a baseline rate of decay in the fiber indicative of a relaxed state of the material; and comparing the baseline rate of decay with the first rate of decay.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 illustrates the electromagnetic spectrum on a logarithmic scale;

FIG. 2 illustrates a prior art CRDS system using mirrors;

FIG. 3 illustrates a prior art CRDS cell using prisms;

FIG. 4 is an illustration of a first exemplary embodiment of the present invention;

FIG. 5A is a end view of a conventional optical fiber;

FIG. 5B is a perspective view of a sensor according to an exemplary embodiment of the present invention;

FIG. 6A is a cross sectional view of fiber optic cable illustrating propagation of radiation within the cable;

FIG. 6B is a cross section of a fiber optic sensor illustrating the evanescent field according to an exemplary embodiment of the present invention

FIG. 6C is a cross section of a fiber optic sensor illustrating the evanescent field according to another exemplary embodiment of the present invention;

FIG. 7 is an illustration of a second exemplary embodiment of the present invention;

FIGS. 8A-8D are illustrations of a fiber optic sensor according to a third exemplary embodiment of the present invention;

FIGS. 9A-9C are illustrations of a fiber optic sensor according to a fourth exemplary embodiment of the present invention;

FIGS. 10A-10C are illustrations of a fiber optic sensor according to a fifth exemplary embodiment of the present invention;

FIG. 11 is a block diagram of an exemplary embodiment of the present invention in a strain measurement application;

FIG. 12 is a detailed view of an exemplary strain sensor for use in the exemplary embodiment of FIG. 11;

FIGS. 13A-13B are perspective views of the stain sensor of FIG. 12 under various degrees of strain; and

FIG. 14 is a chart illustrating an exemplary dynamic range and detectable displacement of the exemplary embodiment of FIG. 11.

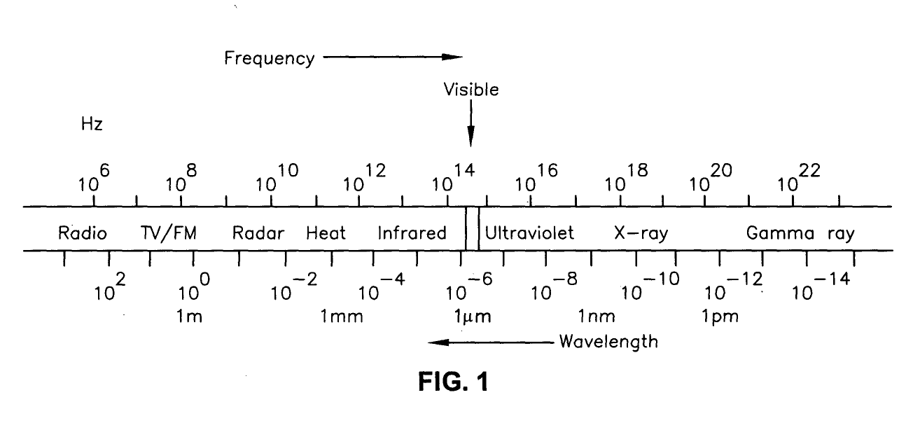

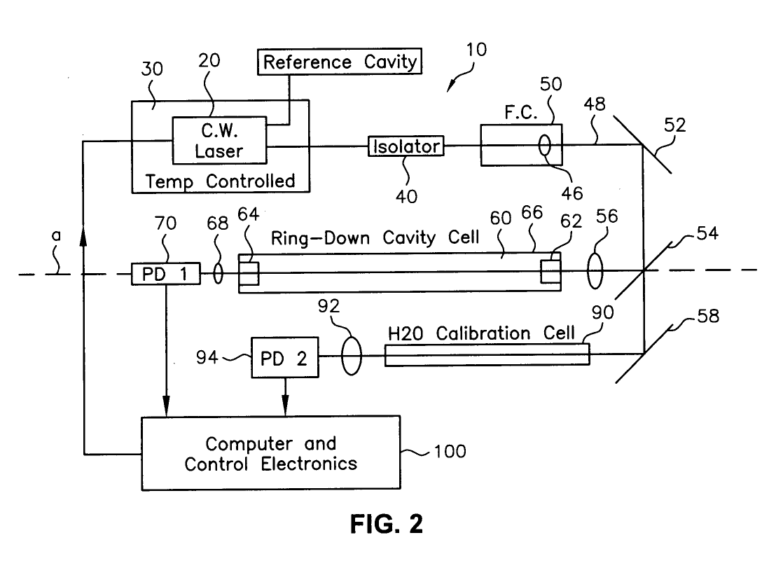

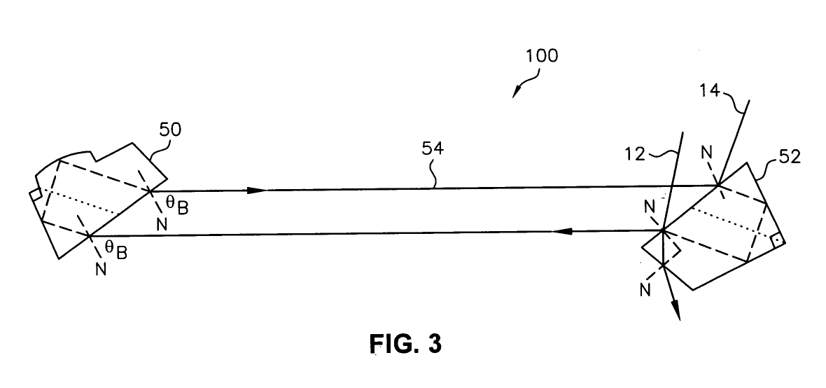

### DETAILED DESCRIPTION OF THE INVENTION

The entire disclosure of U.S. patent applications Ser. No. 10/157,400 filed on May 29, 2002 and Ser. No. 10/017,367 filed Dec. 12, 2001 are expressly incorporated herein by reference.

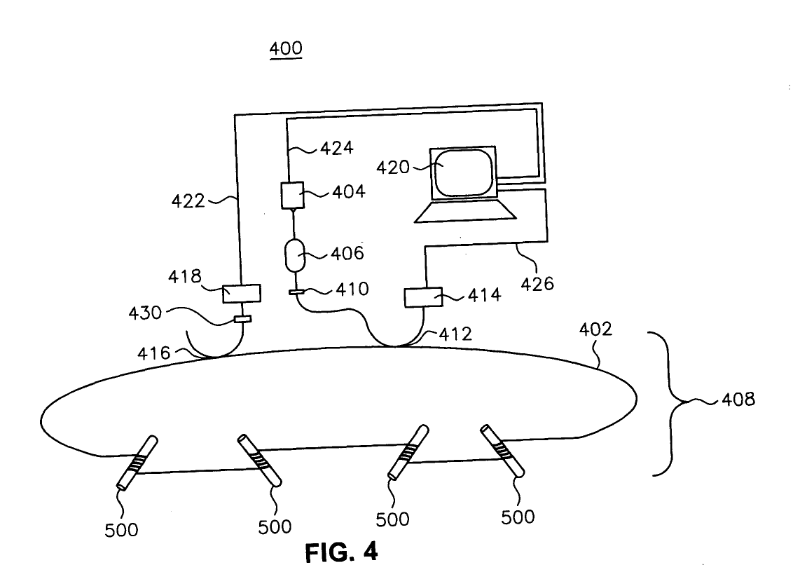

FIG. 4 illustrates fiber optic based ring-down apparatus 400 according to a first exemplary embodiment of the present invention through which trace species, or analytes, in gases and liquids may be detected. In FIG. 4, apparatus 400 includes resonant fiber optic ring 408 which has fiber optic cable 402 and sensors 500 (described below in detail) distributed along the length of fiber optic cable 402. The length of resonant fiber optic ring 408 is easily adaptable to a variety of acquisition situations, such as perimeter sensing or passing through various sections of a physical plant, for example. Although as shown, sensors 500 are distributed along the length of fiber optic loop 408, the invention may be practiced using only one sensor 500, if desired. The distribution of more than one sensor 500 allows for sampling of a trace species at various points throughout the installation site. The invention may also be practiced using a combination of sensors 500 with straight section of fiber 402 exposed to sample liquids or gases, or with only straight sections of fiber 402 exposed to the sample liquid or gas. It is contemplated that the length of resonant fiber optic ring may be as small as about 1 meter or as large as several kilometers.

Coherent source of radiation 404, such as an optical parametric generator (OPG), optical parametric amplifier (OPA) or a laser, for example, emits radiation at a wavelength consistent with an absorption frequency of the analyte or trace species of interest. Coherent source 404 may be a tunable diode laser having a narrow band based on the trace species of interest. An example of a commercially available optical parametric amplifier is model no. OPA-800C available from Spectra Physics, of Mountain View, Calif.

It is contemplated that the present invention may be used to detect a variety of chemical and biological agents harmful to humans and/or animals. It is also contemplated that such detection may be enhanced by coating the surface of the passive fiber optic ring with antibodies that specifically bind the desired antigen.

In the first exemplary embodiment, radiation from coherent source 404 is provided to resonant fiber optic ring 408 through optional optical isolator 406, coupler 410, and evanescent input coupler 412. When coherent source 404 is a diode laser, using optical isolator 406 provides the benefit of minimizing noise in the laser by preventing reflections back into the laser. Evanescent input coupler 412 may provide a fixed percentage of radiation from coherent source 404 into resonant fiber optic ring 408, or may be adjustable based on losses present throughout resonant fiber optic ring 408. Preferably, the amount of radiation provided by evanescent input coupler 412 to resonant fiber optic ring 408 matches the losses present in fiber optic cable 402 and the connectors (not shown). A commercially available evanescent coupler providing 1% coupling (99%/1% split ratio coupling) of radiation is manufactured by ThorLabs of Newton, N.J., having part number 10202A-99. In a preferred embodiment, evanescent input coupler 412 couples less that 1% of the radiation from coherent source 404 into fiber 402.

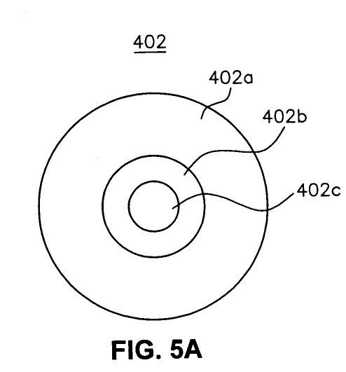

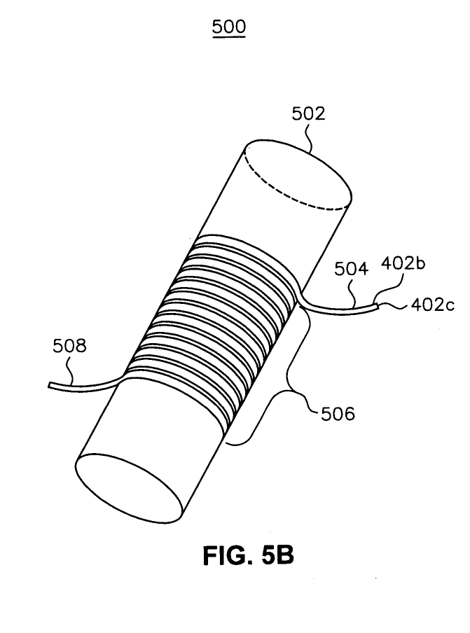

In one exemplary embodiment, to detect the trace species or analyte, a portion of the jacket 402a covering the fiber optic cable 402 is removed to expose cladding 402b that surrounds inner core 402c of fiber optic cable 402. Alternatively, either both jacket 402a and cladding 402b may be removed to expose inner core 402c, or the jacketed portion of fiber optic cable 402 may be exposed to the sample liquid or gas. The latter approach may be useful for example, in the case where the evanescent field (discussed below) extends into the jacket for interaction with the trace species (which has been absorbed or dissolved into the jacket). Removing both the jacket and cladding may not be the most preferred, however, because of the brittle nature of inner core 402c used in certain types of fiber optic cables. A cross section of a typical fiber optic cable is shown in FIG. 5A.

Bending a total internal reflection (TIR) element changes the angle at which the incident electromagnetic wave contacts the reflection surface. In the case of bending an optical fiber about a cylindrical body, the angle of reflection on the surface of the fiber core opposite the body is closer to normal, and the penetration depth of the evanescent field is increased. By wrapping several turns of optical fiber 402 around cylindrical core element 502 (see FIG. 5B), the evanescent field penetration depth is increased and a greater length of fiber can be exposed to the detection fluid in a smaller physical volume. An experimental, verification of the improvement in optical fiber sensing through varying bending radii is discussed by D. Littlejohn et al. in “Bent Silica Fiber Evanescent Absorption Sensors for Near Infrared Spectroscopy,” Applied Spectroscopy 53: 845-849 (1999).

FIG. 5B illustrates an exemplary sensor 500 used to detect trace species in a liquid or gas sample. As shown in FIG. 5B, sensor 500 includes cylindrical core element 502 (which may be solid, hollow or otherwise permeable), such as a mandrel, with a portion of fiber optic cable 402, with cladding 402b exposed (in this example), wrapped around core element 502 over a predetermined length 506. It is also possible to fabricate sensor 500 by wrapping core element 502 where core 402c of fiber optic cable 402 is exposed. The diameter of core element 502 is such that fiber core 402c is formed with less than a critical radius r, at which point excess radiation may be lost through fiber core 402c as it circumscribes core element 502, or fiber integrity is compromised. The critical radius r is dependent on the frequency of the radiation passing through fiber optic cable 402 and/or the composition of the fiber. In a preferred embodiment of the present invention, the radius of core element 502 is between about 1 cm and 10 cm, and most preferably at least about 1 cm. As illustrated, radiation from fiber 402 is provided at input 504 and extracted at output 508. Cylindrical core element 502 may have a spiral groove on its surface in which fiber 402 is placed as well as a means to secure fiber 402 to cylindrical core element 502. Such securing means may take may forms, such as a screw tapped into cylindrical core element 502, an adhesive, such as epoxy or silicon rubber, etc. The invention may be practiced where sensors 500 are integral with fiber 402 or may be coupled to fiber 402 utilizing commercially available fiber-optic connectors.

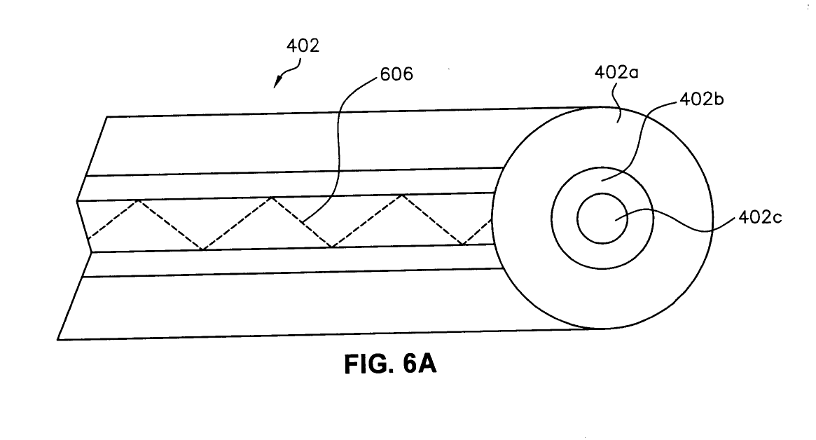

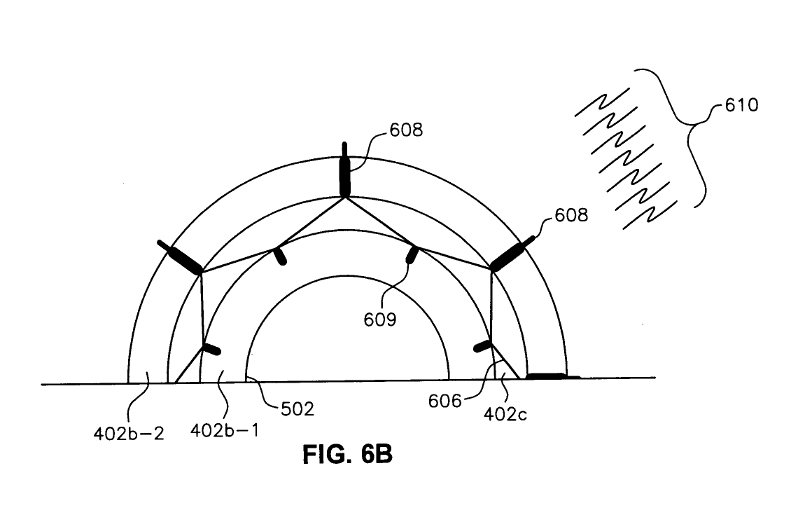

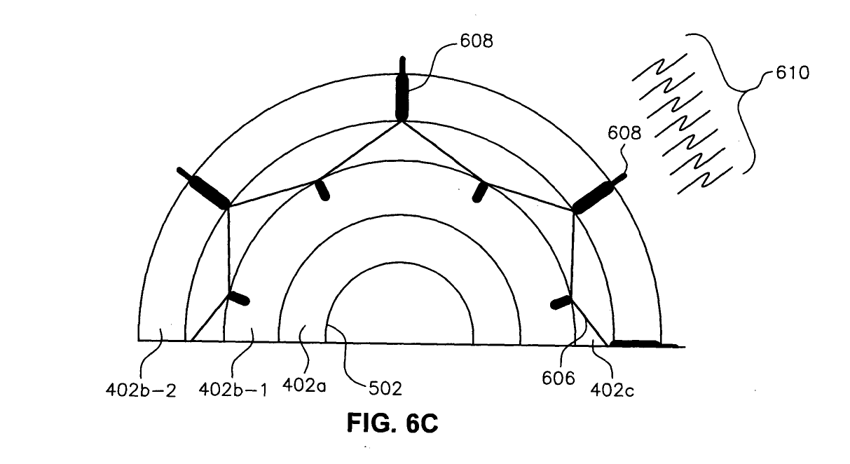

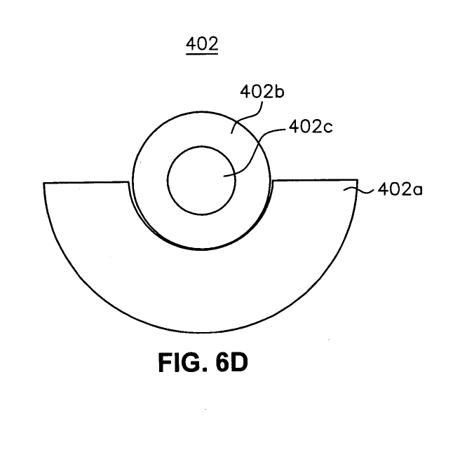

FIG. 6A illustrates how radiation propagates through a typical fiber optic cable. As shown in FIG. 6A, radiation 606 exhibits total internal reflection (TIR) at the boundary between inner core 402c and cladding 402b. There is some negligible loss (not shown) by which radiation is not reflected, but is absorbed into cladding 402b. Although FIG. 6A is described as a fiber optic cable, FIG. 6A and the exemplary embodiments of the present inventions are equally applicable to a hollow fiber, such as a hollow waveguide, in which cladding 402b surrounds a hollow core.

FIG. 6B is a cross sectional view of one exemplary embodiment of sensor 500 which illustrates the effect of wrapping fiber optic cable 402 around core element 502. As shown in FIG. 6B, only jacket 402a is removed from fiber optic cable 402. Radiation 606 travels within core 402c and exhibits total internal reflection at the boundary between inner core 402c and the portion of cladding 402b-1 adjacent core element 502 with a negligible loss 609. On the other hand, in the presence of trace species or analyte 610, evanescent field 608 passes through the interface between inner core 402c and the exposed portion of cladding 402b-2. This essentially attenuates radiation 606 based on the amount of trace species 610 present and is called attenuated total internal reflection (ATR). It should be noted that if there is no a trace species present having an absorption band compatible with the wavelength of the radiation, radiation 606 is not attenuated (other than by inherent loss in the fiber).

FIG. 6C is a cross sectional view of another exemplary embodiment of sensor 500 which illustrates the effect of wrapping fiber optic cable 402 around core element 502 with a portion of jacket 402a remaining intact. As shown in FIG. 6D, only an upper portion of jacket 402a is removed from fiber optic cable 402. Similar to the first exemplary embodiment of sensor 500, radiation 606 travels within core 402c and exhibits total internal reflection at the boundary between inner core 402c and the portion of cladding 402b-1 adjacent core element 502 with negligible loss 609. On the other hand, in the presence of trace species or analyte 610 evanescent field 608 passes through the interface between inner core 402c and the exposed portion of cladding 402b-2.

It is contemplated that the removal of jacket 402a (in either example of sensor 500) may be accomplished by mechanical means, such as a conventional fiber optic stripping tool, or by immersing the portion of the fiber cable in a solvent that will attack and dissolve jacket 402a without effecting cladding 402b and inner core 402c. In the case of partial removal of jacket 402a, the solvent approach may be modified by selectively applying the solvent to the portion of the jacket intended for removal.

To enhance the attraction of analyte molecules of the trace species in a liquid sample, a jacket-less portion of the passive fiber optic ring may be coated with a material to selectively increase a concentration of the trace species at the coated portion of the fiber optic ring. An example of one such coating material is polyethylene. Additionally, antigen specific binders may be used to coat the fiber to attract a desired biological analyte with high specificity.

Referring again to FIG. 4, the radiation that remains after passing through sensors 500 continues through fiber loop 402. A portion of that remaining radiation is coupled out of fiber optic loop 402 by evanescent output coupler 416. Evanescent output coupler 416 is coupled to processor 420 through detector 418 and signal line 422. Processor 420 may be a PC, for example, having a means for converting the analog output of detector 418 into a digital signal for processing. Processor 420 also controls coherent source 404 through control line 424. Once the signals are received from detector 418 by processor 420, the processor may determine the amount and type of trace species present based the decay rate of the radiation received.

Optionally, wavelength selector 430 may be placed between evanescent output coupler 416 and detector 418. Wavelength selector 430 acts as a filter to prevent radiation that is not within a predetermined range from being input into detector 418.

Detector 414 is coupled to the output of input coupler 412. The output of detector 414 is provided to processor 420 via signal line 422 for use in determining when resonant fiber optic ring 402 has received sufficient radiation by which to perform trace species analysis.

In the case of detection of trace species or analytes in liquids, the index of refraction of the liquid must be lower than the index of refraction of the fiber optic cable. For example, given a fiber optic cable having an index of refraction of n=1.46, the invention may be used to detect trace species dissolved in water (n=1.33) and many organic solvents, including methanol (n=1.326), n-hexane (n=1.372), dichloromethane (n=1.4242), acetone (n=1.3588), diethylether (n=1.3526), and tetrahydrofuran (n=1.404), for example. An extensive list of chemicals and their respective index of refraction may be found in CRC Handbook of Chemistry and Physics, 52^{nd} edition, Weast, Rober C., ed. The Chemical Rubber Company: Cleveland Ohio, 1971, p. E-201, incorporated herein by reference. There are other types of optical fiber available with different indexes of refraction, and the present invention can be tailored to a given liquid matrix assuming the optical fiber has both a higher index of refraction than the liquid and effectively transmits light in the region of an absorption band by the target analyte.

There are many different types of optical fiber currently available. One example is Corning's SMF-28e fused silica fiber which has a standard use in telecommunications applications. Specialty fibers exist that transmit light at a multitude of different wavelengths, such as a 488 nm/514 nm single mode fiber, manufactured by 3M of Austin, Tex. (part no. FS-VS-2614), 630 nm visible wavelength single-mode fiber manufactured by 3M of Austin, Tex. (part no. FS-SN-3224), 820 nm standard single-mode fiber manufactured by 3M of Austin, Tex. (part no. FS-SN-4224), and 0.28-NA fluoride glass fiber with 4-micron transmission, manufactured by KDD Fiberlabs of Japan (part no. GF-F-160). Further, and as mentioned above, fiber optic cable 402 may be a hollow fiber.

It is contemplated that fiber 402 may be a mid-infrared transmitting fiber to allow for access to spectral regions having much higher analyte absorption strengths, thereby increasing the sensitivity of the apparatus 400. Fibers that transmit radiation in this region are typically made from fluoride glasses.

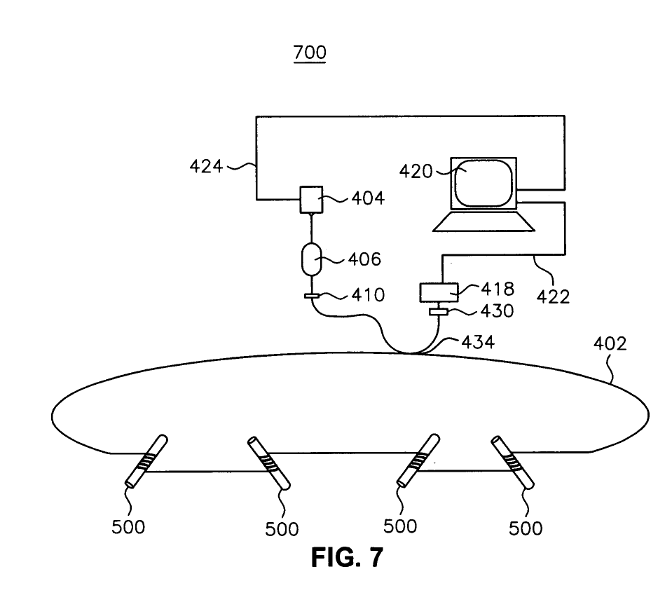

FIG. 7 illustrates a second exemplary embodiment of the present invention through which trace species, or analytes, in gases and liquids may be detected. In describing FIG. 7, elements performing similar functions to those described with respect to the first exemplary embodiment will use identical reference numerals. In FIG. 7, apparatus 700 uses a similar resonant fiber optic ring 408 including fiber optic cable 402 and sensors 500. Radiation from coherent source 404 is provided to resonant fiber optic ring 408 through optional optical isolator 406, coupler 410, and evanescent input/output coupler 434. Evanescent input/output coupler 434 may provide a fixed percentage of radiation from coherent source 404 into resonant fiber optic ring 408, or may be adjustable based on losses present throughout resonant fiber optic ring 404. In the exemplary embodiment evanescent input/output coupler 434 is essentially a reconfiguration of evanescent input coupler 412 discussed above with respect to the first exemplary embodiment. It a preferred embodiment, evanescent input/output coupler 434 couples less that 1% of the radiation from laser 404 into fiber 402.

Detection of trace species is similar to that described in the first exemplary embodiment and is therefore not be repeated here.

The radiation that remains after passing through sensors 500 continues through fiber loop 402. A portion of that remaining radiation is coupled out of fiber optic loop 402 by evanescent input/output coupler 434. Evanescent input/output coupler 434 is coupled to processor 420 through detector 418 and signal line 422. As in the first exemplary embodiment, processor 420 also controls coherent source 404 through control line 424. Once the signals are received from detector 418 by processor 420, the processor may determine the amount and type of trace species present based the decay rate of the radiation received.

Optionally, wavelength selector 430 may be placed between evanescent input/output coupler 434 and detector 418. Wavelength selector 430 acts as a filter to prevent radiation that is not within a predetermined range from being input into detector 418. Wavelength selector 430 may also be controlled by processor 420 to prevent radiation from coherent source 404 “blinding” detector 418 during the time period after the radiation from coherent source 404 was coupled into fiber 402.

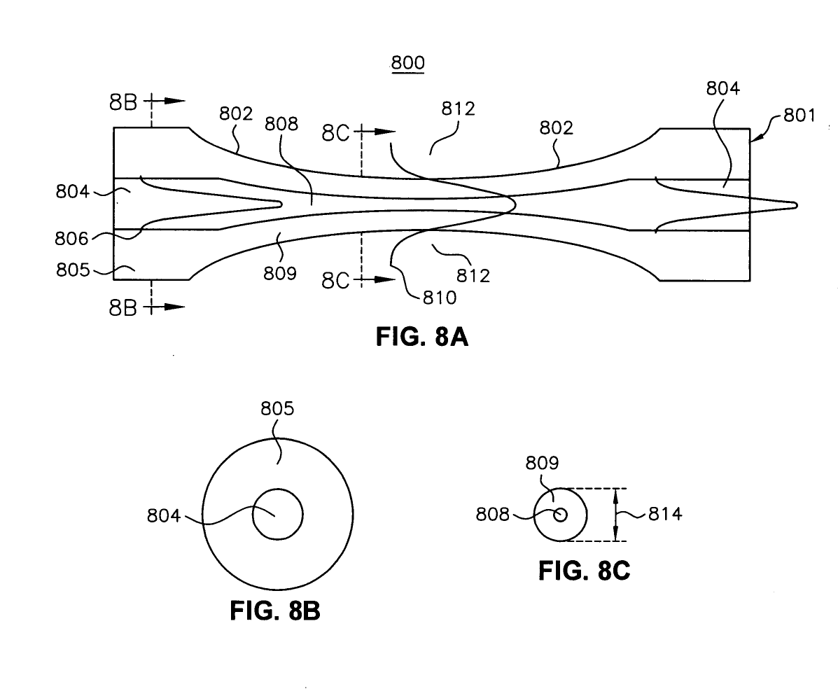

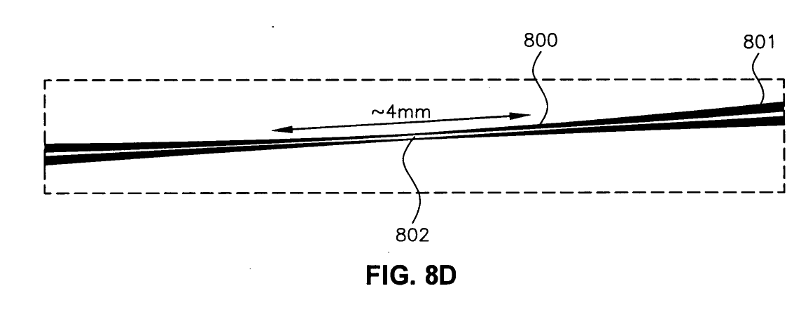

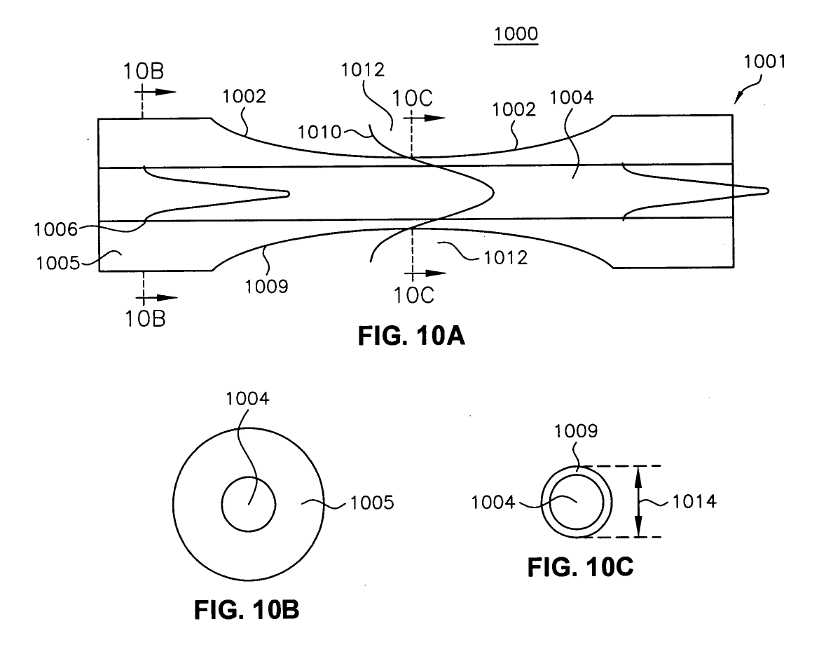

FIGS. 8A-8D illustrates another exemplary sensor 800 used to detect trace species in a liquid or gas sample. As shown in FIGS. 8A and 8D, sensor 800 is formed from fiber 801 by tapering the inner core 804 and cladding 805 to create tapered region 802 having tapered inner core 808 and tapered cladding 809. The forming of tapered region 802 may be accomplished using either of two techniques. The first technique is heating of a localized section of fiber 801 and simultaneous adiabatic pulling on either side of the region in which it is desired to form sensor 800. This procedure creates a constant taper in fiber 801. This tapered fiber can then be for used as a spectroscopic sensor according to the first exemplary embodiment, for example. In the second exemplary technique, tapered region 802 may be formed by using a chemical agent to controllably remove a predetermined thickness of fiber cladding 805 to form tapered cladding 809. A detailed description of a sensor formed using the second technique is described below with respect to FIGS. 10A-10C.

FIG. 8B illustrates a cross section of sensor 800 in the pre taper and post taper regions. As shown in FIG. 8B, inner core 804 and cladding 805 are in an unmodified state. It should be noted, for simplicity, the illustrations and description do not refer to the jacketing of fiber optic cable 801, though such jacketing is assumed to be in place for at least a portion of fiber optic cable 801.

FIG. 8C, illustrates a cross section of sensor 800 in tapered region 802. As shown in FIG. 8C, tapered inner core 808 and tapered cladding 809 each have a significantly reduced diameter as compared to inner core 804 and cladding 805. Tapered region 802 may be of any desired length based on the particular application. In the exemplary embodiment, as shown in FIG. 8D, for example, the length of the tapered region is approximately 4 mm with a waist diameter 814 of about 12 microns.

Referring again to FIG. 8A, evanescent field 806 in the region of inner core 804 is narrow and confined when compared to enhanced evanescent field 810 in taped region 802. As illustrated, enhanced evanescent field 810 is easily exposed to the trace species (not shown) as discussed above with respect to the earlier exemplary embodiments and, thus, is better able to detect the trace species in region 812.

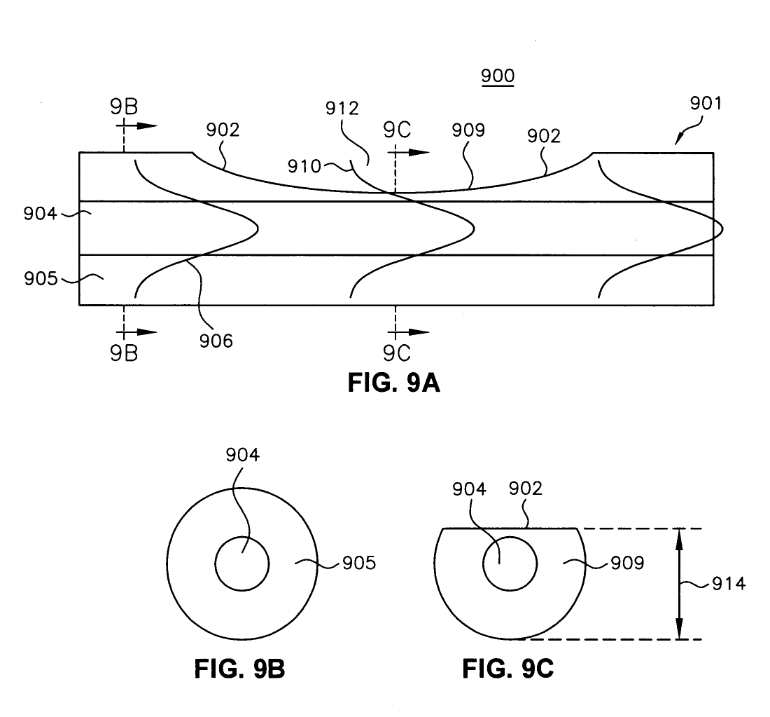

FIGS. 9A-9C illustrate yet another exemplary sensor 900 used to detect trace species in a liquid or gas sample. As shown in FIG. 9A, sensor 900 is formed from fiber 901 by removing a portion of cladding 905 to create a substantially “D” shaped cross section region 902. The forming of “D” shaped cross section region 902 may be accomplished by polishing one side of optical fiber cladding 905 using an abrasive, for example. The abrasive is used to remove cladding 905 in continuously increasing depths along region 902 to preserve guided mode quality, ultimately reaching a maximum depth at the point of minimum cladding thickness 909. This area of lowest cladding thickness represents the region of maximum evanescent exposure 910.

FIGS. 10A-10C illustrate still another exemplary sensor 1000 used to detect trace species in a liquid or gas sample. Sensor 1000 is formed using the second technique described above with respect to the tapered sensor exemplary embodiment. As shown in FIG. 10A, sensor 1000 is formed from fiber 1001 by removing a portion of cladding 1005 using a chemical agent, known to those of skill in the art, to create tapered region 1002 having tapered cladding 1009. It is important that the chemical agent not be permitted to disturb or remove any portion of the inner core, as this may introduce significant losses in sensor 1000.

FIG. 10B illustrates a cross section of sensor 1000 in the pre taper and post taper regions. As shown in FIG. 10B, inner core 1004 and cladding 1005 are in an unmodified state. It should again be noted, for simplicity, the illustrations and description do not refer to the jacketing of fiber optic cable 1001, though such jacketing is assumed to be in place for at least a portion of fiber optic cable 1001.

FIG. 10C illustrates a cross section of sensor 1000 in tapered region 1002. As shown in FIG. 10C, inner core 1004 is not affected while tapered cladding 1009 has a significantly reduced diameter as compared to cladding 1005. Tapered region 1002 may be of any desired length based on the particular application. In the exemplary embodiment, for example, the length of the tapered region is approximately 4 mm with a waist diameter 1014 of about 12 microns.

Referring again to FIG. 10A, evanescent field 1006 in the region of inner core 1004 is narrow and confined when compared to enhanced evanescent field 1010 in tapered region 1002. As illustrated, enhanced evanescent field 1010 is easily exposed to the trace species (not shown) as discussed above with respect to the earlier exemplary embodiments and, thus, is better able to detect the trace species in region 1012.

With respect to the above described sensors 800, 900 and 1000, losses created in the optical fiber by forming the sensors may be balanced with the amount of evanescent field exposure by determining the appropriate taper diameter or polish depth for the desired detection limits prior to fiber alteration. Further, it may be desirable to provide a protective mounting for sensors 800, 900 and/or 1000 to compensate for increased fragility due to the respective tapering and polishing operations.

It is contemplated that sensors 800, 900 and/or 1000 may be used in either as an unrestricted fiber, on a cylindrical core element 502 (which may be solid, hollow or otherwise permeable), such as a mandrel (shown in FIG. 5B) or in a loop or bent configuration (not shown).

Sensors 800, 900 and 1000 may be further enhanced by coating the sensing region with a concentrating substance, such as a biological agent to attract an analyte of interest. Such biological agents are known to those of ordinary skill in the art. It is also contemplated that several detecting regions 800, 900 and/or 1000 may be formed along a length of a fiber optic cable to produce a distributed ring down sensor.

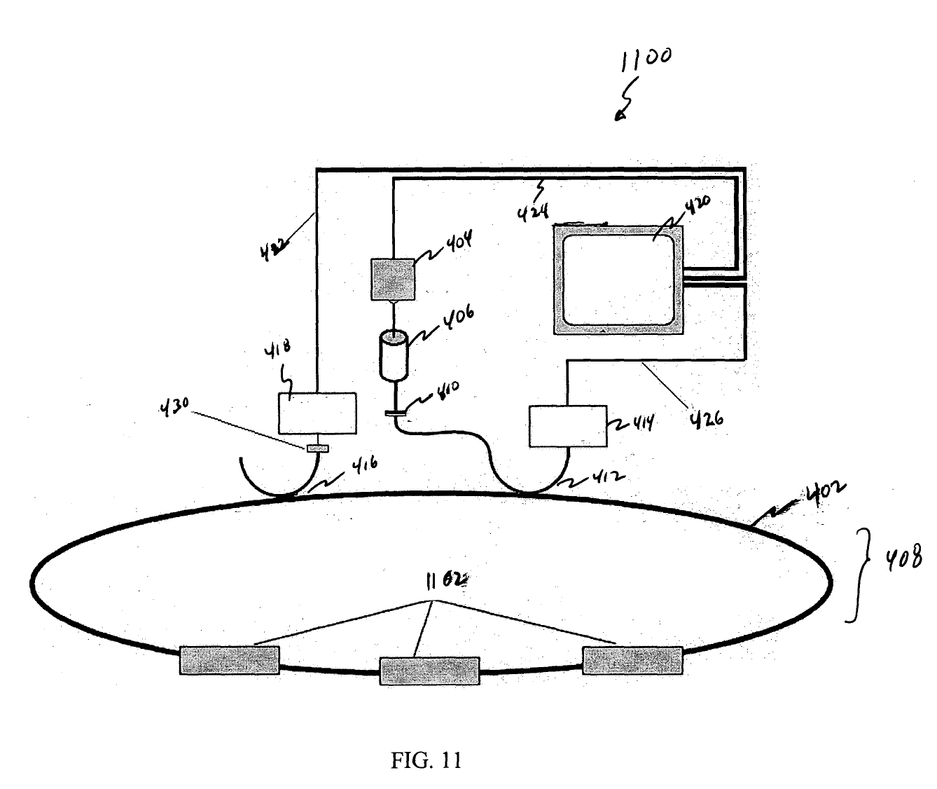

FIG. 11 illustrates fiber optic based ring-down apparatus 1100 according to a second exemplary embodiment of the present invention through which strain induced in materials may be detected. Elements in common with those of the first exemplary embodiment have identical reference numbers.

As shown in FIG. 11, apparatus 1100 includes resonant fiber optic ring 408 which has fiber optic cable 402 and one or more sensors 1102 (described below in detail) distributed along the length of fiber optic cable 402. The length of resonant fiber optic ring 408 is easily adaptable to a variety of data acquisition situations, such as perimeter sensing or passing through various sections of a physical plant, for example. Although as shown, sensors 1102 are distributed along the length of fiber optic loop 408, the invention may be practiced using only one sensor 1102, if desired. The distribution of more than one sensor 1102 allows for sampling of a material strain at various points throughout the structure being monitored. Sensors 1102 may be an integral part of or coupled to fiber 402. It is contemplated that the length of resonant fiber optic ring may be as small as about 1 meter or as large as several kilometers.

The wavelength of light affects optical mode conversion and therefore sensitivity, but this effect can be balanced by the taper design. For highest sensitivity, the wavelength should preferably be chosen to match the design wavelength of the fiber. Although some wavelengths may be more sensitive to mode conversion and therefore strain, it is anticipated that wavelengths far from the fiber's design wavelength will erode the desired sensitivity by causing too much transmission loss and an unusable ring-down signal. In one exemplary embodiment, the wavelength is 1550 nm (the minimum loss wavelength in telecom fiber), for which most inexpensive, durable telecommunications components are optimized. Other wavelengths are also suitable, however, such as 1300 nm (the zero dispersion wavelength in telecom fiber), although it is contemplated that the present invention may be used with wavelengths in the range of between 1250 nm and 1650 nm.

Coherent source of radiation 404 may be an optical parametric generator (OPG), optical parametric amplifier (OPA) or a laser, for example, having a wavelength selected to match the design wavelength of the fiber. An example of a commercially available optical parametric amplifier is model no. OPA-800C available from Spectra Physics, of Mountain View, Calif.

In the first exemplary embodiment, radiation from coherent source 404 is provided to resonant fiber optic ring 408 through optional optical isolator 406, coupler 410, and evanescent input coupler 412. When coherent source 404 is a diode laser, using optical isolator 406 provides the benefit of minimizing noise in the laser by preventing reflections back into the laser. Evanescent input coupler 412 may provide a fixed percentage of radiation from coherent source 404 into resonant fiber optic ring 408, or may be adjustable based on losses present throughout resonant fiber optic ring 408. Preferably, the amount of radiation provided by evanescent input coupler 412 to resonant fiber optic ring 408 matches the losses present in fiber optic cable 402 and the connectors (not shown). A commercially available evanescent coupler providing 1% coupling (99%/1% split ratio coupling) of radiation is manufactured by ThorLabs of Newton, N.J., having part number 10202A-99. In a preferred embodiment, evanescent input coupler 412 couples less that 1% of the radiation from coherent source 404 into fiber 402.

In one exemplary embodiment, sensors 1102 are based on sensor 800 as described with respect to FIGS. 8A-8D. In another exemplary embodiment, sensors 1102 are based on sensor 1000 as described with respect to FIGS. 10A-10C. One difference between sensors 1102 and 800/1000, however, is that sensor 1102 is not wound on a core, but rather is substantially linear and coupled to substrate under test 1106 with a well-known adhesive 1108, such as epoxy or tape, for example. When attaching sensor 1102 to substrate 1106, a predetermined amount of relief or slack (shown as region 1104 in the Figure) is provided between the attaching points to account for any strain induced in substrate 1106. In one exemplary embodiment, region 1104 may be shaped when sensor is applied to substrate 1106. In another exemplary embodiment, such as for high sensitivity applications, region 1104 may be preformed before sensor 1102 is attached to substrate 1106.

In yet another exemplary embodiment, sensor 1102 may be a non-tapered fiber that includes a fiber bragg grating and coupled to substrate 1106 as discussed above.

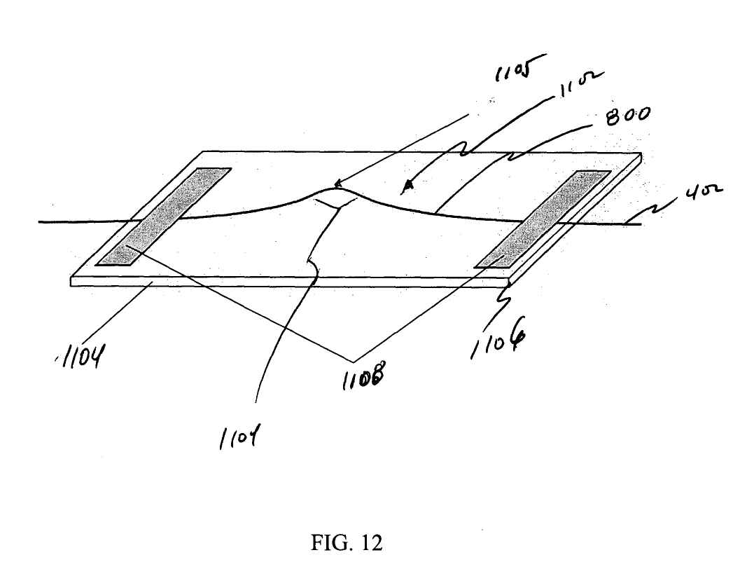

When substrate 1106 is in a relaxed state, such as illustrated in FIG. 12, a measurement of time for radiation induced into fiber optic ring 408 to ring-down is determined. This time is a baseline measure of substrate 1106 in its relaxed state. Changes in the shape of sensor 1102 in region 1104 will effect the ring-down rate in the system. This change in ring-down time is a measure of the strain induced into substrate 1106.

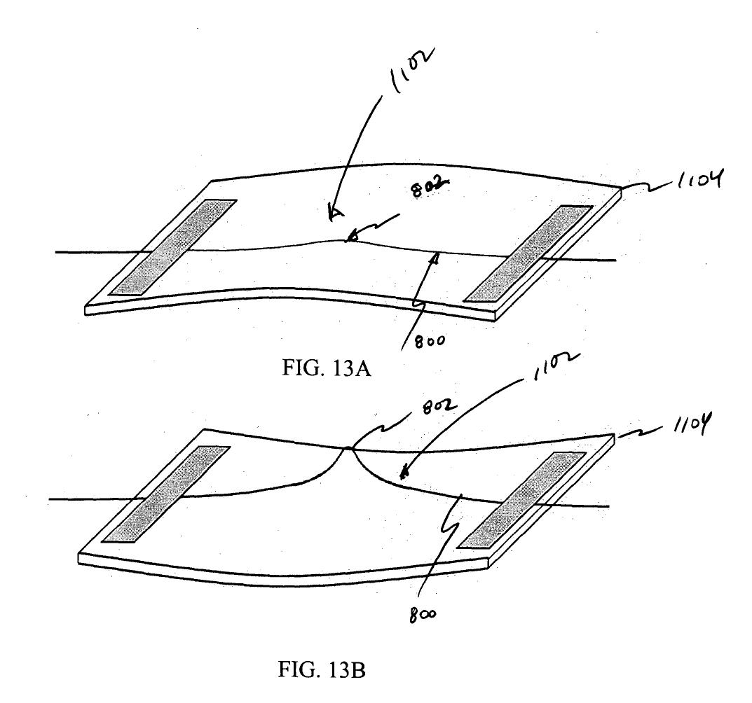

Referring now to FIGS. 13A-13B, various types of exemplary strain (the change in length (or width) of the substrate divided by its original length (or width)) induced into substrate 1106 are illustrated. As shown if FIGS. 13A-13B, when a strain is applied to substrate 1106, region 1104 is either relaxed or enhanced depending on the direction of movement in substrate 1106. As a result of the change in shape of region 1104, the ring-down time measured by the system changes. This change in ring-down time is indicative of the degree of strain induced in substrate 1106 and originates from optical mode conversion within the tapered region from the lowest order propagating mode to higher order, more lossy modes. Specific parameters of sensor 1102, such as length and waist diameter of the tapered region can be selected to achieve either very large dynamic range, covering several orders of magnitude, or extremely high sensitivity (on the order of one micro-strain or better).

Although FIGS. 12-13B show a single sensor 1102 attached to the substrate under test, the invention is not so limited. It is also possible to form sensor 1102 such that it has multiple tapered regions spaced apart from one another such that multiple axes of substrate 1106 may be measured. In one exemplary embodiment, tapered region 1104 may be between 5-25 cm long, for example. Substrate 1106, one the other hand, may be of any size up to several meters in each direction. In all other respects this embodiment is similar to the first exemplary embodiment.

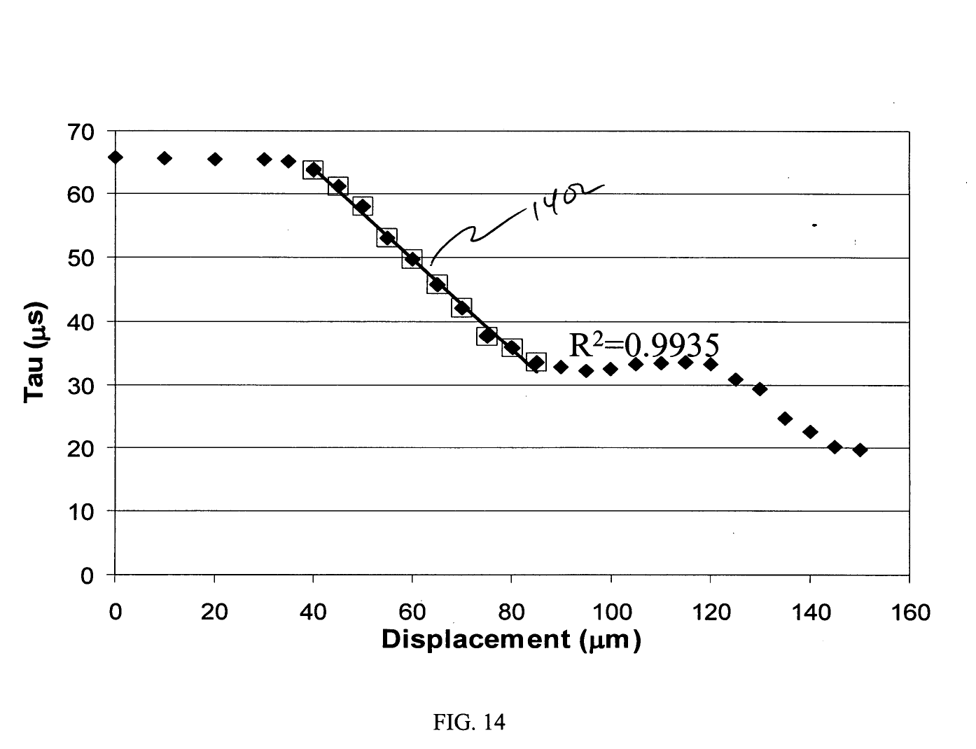

FIG. 14 is a chart illustrating the extent of the dynamic range and detectable displacement for an exemplary tapered sensor. As shown, in linear region 1402 the noise equivalent displacement is about 0.3693 μm (˜370 nm) based on a Δt of 0.263 μs over a 10 cm taper. This corresponds to 37 με (microstrain). By using different taper parameters (combinations of taper waste and taper length), the dynamic range can be extended to several thousand microstrain or the sensitivity optimized to measure sub-micro-strain changes.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed is:

1. An apparatus for use with a coherent source of radiation in order to measure a strain induced into a substrate, the apparatus comprising:
a passive fiber optic ring;
at least one sensor having a predetermined shape and in line with the fiber optic ring, the at least one sensor coupled to the substrate;
coupling means for i) introducing a portion of radiation emitted by the coherent source into the passive fiber optic ring and ii) receiving a portion of the radiation resonant in the passive fiber optic ring;
a detector for detecting a level of the radiation received by the coupling means and generating a signal responsive thereto; and
a processor coupled to the detector for determining a level of the strain inducing into the substrate based on a rate of decay of the radiation in the passive fiber optic ring.

2. The apparatus according to claim 1, wherein the predetermined shape is a slack area formed between ends of the sensor where it is coupled to the substrate.

3. The apparatus according to claim 2, wherein the signal generated by the detector is based on a change in the predetermined shape of the sensor as the strain is induced into the substrate.

4. The apparatus according to claim 2, wherein the predetermined shape is disposed between ends of the sensor.

5. The apparatus according to claim 1, wherein a first one of the at least one sensor is oriented along a first axis of the substrate.

6. The apparatus according to claim 1, wherein a second one of the at least one sensor is oriented along a second axis of the substrate.

7. The apparatus according to claim 1, wherein the at least one sensor includes a fiber bragg grating (FBG).

8. The apparatus according to claim 1, wherein the coupling means is a single optical coupler.

9. The apparatus according to claim 1, further comprising a filter placed in an optical path between the coupling means and the detector to selectively pass the received portion of radiation from the passive fiber optic ring to the detector.

10. The apparatus according to claim 9, wherein the filter passes radiation to the detector based on a wavelength of the radiation.

11. The apparatus according to claim 1, wherein the coupling means includes i) a first coupler for introducing the portion of the radiation emitted by the coherent source to a first section of the optical fiber and ii) a second coupler for receiving the portion of the radiation in the optical fiber at a second section thereof.

12. The apparatus according to claim 1, wherein the predetermined shape is a tapered portion formed between ends of the sensor, the predetermined shape exposed to a surrounding ambient.

13. The apparatus according to claim 12, wherein an evanescent field of the radiation traveling within the fiber is exposed to the surrounding ambient.

14. The apparatus according to claim 12, wherein the tapered portion is formed by heating and adiabatic stretching of the optical fiber.

15. The apparatus according to claim 1, wherein the coherent source of radiation is an optical parametric generator.

16. The apparatus according to claim 1, wherein coherent source of radiation is an optical parametric amplifier.

17. The apparatus according to claim 1, wherein coherent source of radiation is a laser.

18. The apparatus according to claim 1, wherein the coherent source of radiation is a pulsed laser.

19. The apparatus according to claim 1, wherein the coherent source of radiation is a continuous wave laser.

20. The apparatus according to claims 17, 18 or 19, wherein the laser is an optical fiber laser.

21. The apparatus according to claim 19, wherein the continuous wave laser is a tunable diode laser having a narrow band.

22. The apparatus according to claim 21, further comprising an isolator coupled between the laser and the coupling means and in line with the radiation emitted from the laser, the isolator minimizing noise in the laser.

23. The apparatus according to claim 1, wherein the dissipation of the radiation from the fiber as the strain is induced in the substrate changes a rate of decay of the radiation received by the coupling means.

24. The apparatus according to claim 1, wherein the passive optical fiber is formed from one of fused silica, sapphire and fluoride based glass.

25. The apparatus according to claim 1, wherein the passive optical fiber is formed from a hollow fiber.

26. The apparatus according to claim 24 or 25, wherein the passive optical fiber is a single mode fiber.

27. The apparatus according to claim 24 or 25, wherein the passive optical fiber is a multi-mode fiber.

28. The apparatus according to claim 1, wherein the coherent source is a single mode laser tunable in the wavelength region of about 1250 nm and about 1650 nm.

29. The apparatus according to claim 1, wherein the coherent source has a wavelength region of about 1300 nm.

30. The apparatus according to claim 1, wherein the coherent source has a wavelength region of about 1550 nm.

31. The apparatus according to claim 1, wherein the passive optical fiber resonates at a wavelength between a visible to a mid-infrared region of an electro-magnetic spectrum.

32. The apparatus according to claim 1, further comprising an input detector for determining when energy from the laser is provided to the optical fiber.

33. The apparatus according to claim 32, further comprising control means to deactivate the laser based on the receiving means receiving radiation from the optical fiber after the input detector determines that the laser provided energy to the optical fiber.

34. The apparatus according to claim 33, wherein the control means and the input detector are coupled to the processing means.

35. The apparatus according to claim 1, wherein the portion of the radiation coupled into the optical fiber is less than about 1% of the radiation provided to the coupling means.

36. The apparatus according to claim 1, wherein the portion of the radiation coupled into the optical fiber is variable.

37. The apparatus according to claim 1, wherein the portion of the radiation coupled into the optical fiber is varied based on a loss within the passive fiber optic loop.

38. The apparatus according to claim 37, wherein the loss within the optical fiber is based on at least connector losses and fiber losses.

39. The apparatus according to claim 1, wherein the optical fiber is at least about 1 meter long.

40. The apparatus according to claim 1, wherein the optical fiber is at least about 10 meters long.

41. The apparatus according to claim 1, wherein the optical fiber is at least about 1 Km long.

42. An apparatus for measurement of strain comprising:
a passive resonant fiber optic ring;
at least one sensor in line with the fiber optic ring, each of the at least one sensor having a tapered portion;
a coherent source emitting radiation;
a first optical coupler to provide at least a portion of the radiation emitted by the coherent source to a first section of the passive resonant fiber ring;
a second optical coupler for receiving a portion of the radiation in the passive resonant fiber ring from a second section of the resonant fiber ring; and
a processor coupled to the second optical coupler for determining a level of the strain based on a rate of decay of the radiation received by the second optical coupler.

43. The apparatus according to claim 42, further comprising a first optical detector coupled between the second optical coupler and the processor for generating a signal responsive to the radiation received by the second optical coupler.

44. The apparatus according to claim 42, further comprising a second optical detector coupled between the first optical coupler and the processor for determining when energy from the laser is provided to the passive fiber optic ring.

45. The apparatus according to claim 44, wherein the second optical detector generates a trigger signal to the processor responsive to receiving radiation from the coherent source.

46. The apparatus according to claim 42, wherein the first and second optical couplers are a unitary coupler.

47. The apparatus according to claim 42, wherein each of the at least one sensor comprises a preformed portion disposed between ends of the sensor.

48. A method for measuring a strain in a material, the method comprising:
forming a sensor from an optical fiber by tapering a portion the optical fiber;
coupling the sensor to the material such that a portion between the ends of the sensor has a predetermined amount of slack;
exposing the material to a strain;
emitting radiation from a coherent source;
coupling at least a portion of the radiation emitted from the coherent source into the fiber optic ring;
receiving a portion of the radiation traveling in the fiber optic ring; and
determining a level of strain based on a first rate of decay of the radiation within the fiber optic ring.

49. A method according to claim 48, further comprising the step of exposing an evanescent field of the radiation traveling within the fiber to an ambient surrounding the material.

50. A method according to claim 49, further comprising the steps of:
determining a baseline rate of decay in the fiber indicative of a relaxed state of the material; and
comparing the baseline rate of decay with the first rate of decay.
